(19) United States
(12) Patent Application Publication
(10) Pub. No.: US 2018/0178169 A1
(43) Pub. Date: Jun. 28, 2018

(54) Multilayer Composite Gas Separation Membranes with two Selective Layers

(71) Applicant: Fujifilm Corporation, Tokyo (JP)

(72) Inventors: Satoshi Yoneyama, Tilburg (NL); Yujiro Itami, Tilburg (NL)

(21) Appl. No.: 15/736,806

(22) PCT Filed: Jun. 14, 2016
(86) PCT No.: PCT/GB2016/051757

§ 371 Date: Dec. 15, 2017

(30) Foreign Application Priority Data
Jun. 17, 2015 (GB) 1510648.7

(51) Int. Cl. B01D 69/12; B01D 71/64; B01D 71/70; B01D 71/16; B01D 53/22; B01D 69/02; B01D 67/00

(52) U.S. Cl. CPC B01D 69/12; B01D 71/64; B01D 71/70; B01D 71/16; B01D 2325/04; B01D 69/02; B01D 67/0002; B01D 2325/20; B01D 53/228

(57) ABSTRACT

A composite membrane comprising: (A) a porous support; (B) optionally a gutter layer; (C) a first discriminating layer; (D) an outermost layer; and (E) a non-discriminating layer interposed between the first discriminating layer (C) and the outermost layer (D); wherein the outermost layer (D) is a discriminating layer comprising a polyimide polymer.

This invention relates to composite membranes and to their use for the separation of gases.

Composite membranes comprising a porous support, a gas-permeable polymeric layer (often referred to as a “gutter layer”) and an outermost discriminating layer are known in the art. Each of these components is an important contributor to the overall performance of the membrane. The porous support provides the membrane with mechanical strength; the discriminating layer selectively allows some gases to permeate through the membrane more quickly than others; while the gutter layer provides a smooth, gas-permeable non-discriminating surface between the porous support and the discriminating layer without actually discriminating between gases. Composite membranes having one discriminating layer are described in U.S. Pat. No. 5,286,280.

Typically a mixture of gasses is brought into contact with one side of the composite membrane and at least one of the gases permeates through the discriminating layer faster than the other gas(es). In this way, a feed gas stream is separated into two streams, one of which is enriched in the selectively permeating gas(es) and the other of which is depleted.

The present invention aims to provide composite membranes having good selectivity, robustness and high gas flux.

According to a first aspect of the present invention there is provided a composite membrane comprising:
(A) a porous support;
(B) optionally a gutter layer;
(C) a first discriminating layer;
(D) an outermost layer; and
(E) a non-discriminating layer interposed between the first discriminating layer (C) and the outermost layer (D);
   wherein the outermost layer (D) is a discriminating layer comprising a polyimide polymer.

### BRIEF DESCRIPTION OF THE DRAWINGS

FIG. 1 and FIG. 2 are schematic representations of composite membranes 1a and 1b according to the present invention.

FIG. 3 and FIG. 4 are schematic representations of comparative composite membranes falling outside of the present claims.

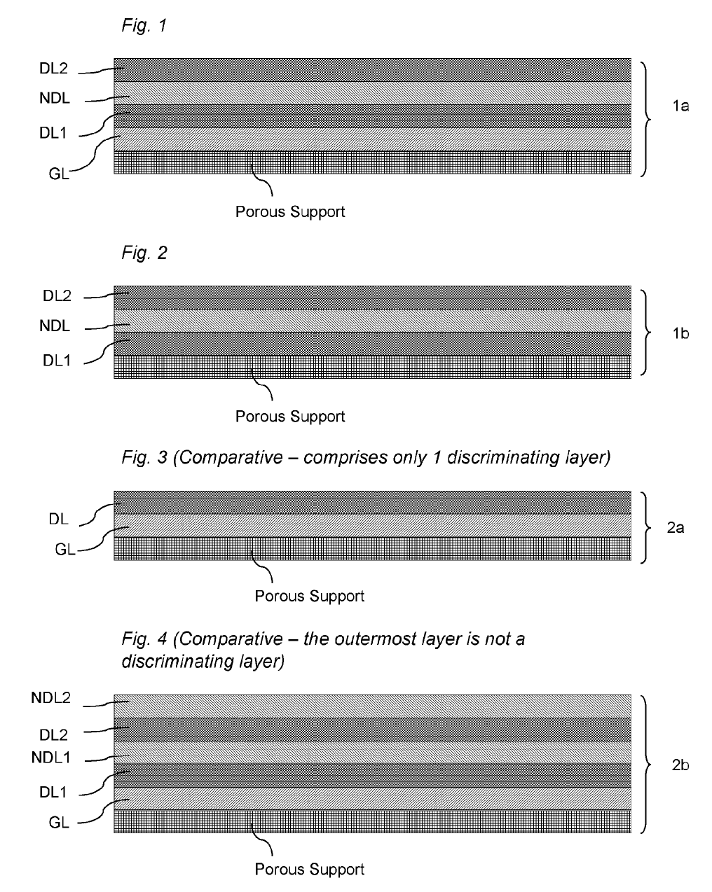

FIG. 1 is a schematic representation of composite membrane 1a comprising a porous support carrying a gutter layer (GL), discriminating layer (DL1), non-discriminating layer (NDL) and an outermost discriminating layer (DL2), in that order. Although FIG. 1 shows the layers as all having the same thickness for ease of viewing, in practice the discriminating layers (DL1 and DL2) are usually much thinner than the gutter layer (GL) and the non-discriminating layer (NDL).

FIG. 2 is a schematic representation of composite membrane 1b which has exactly the same layers as mentioned above for FIG. 1, except that there is no gutter layer (GL).

FIG. 3 is a schematic representation of a comparative composite membrane 2a, illustrating the typical layers used in conventional gas separation membranes. The composite membrane 2a comprises a porous support carrying a gutter layer (GL) and one discriminating layer (DL1), in that order. This construction and its properties are described in Comparative Example 1 in the Examples section of this specification.

FIG. 4 is a schematic representation of a comparative composite membrane 2a comprising a porous support, a gutter layer (GL), discriminating layer (DL1), non-discriminating layer (NDL1), a second discriminating layer (DL2) and a second non-discriminating layer (NDL2), in that order. In this comparative construction, outermost layer is not a discriminating layer. Instead, the outermost layer in FIG. 4 is the second non-discriminating layer (NDL2). This construction and its properties are described in Comparative Examples 4 and 5 in the Examples section of this specification.

Surprisingly the composite membranes according to the present invention have a particularly good combination of high selectivity and good robustness and can separate gases at very high fluxes compared to the prior art of membranes comprising only one discriminating layer.

The primary purpose of the porous support is to provide mechanical strength to the membrane without materially reducing gas flux. Therefore the porous support is typically open pored (before it is converted into the composite membrane), relative to the discriminating layer.

The porous support may be, for example, a microporous organic or inorganic membrane, or a woven or non-woven fabric. Preferably the porous support is organic. The porous support may be constructed from any suitable material. Examples of such materials include polysulfones, polyethersulfones, polyimides, polyetherimides, polyamides, polyamideimides, polyacrylonitrile, polycarbonates, polyesters, polyacrylates, cellulose acetate, polyethylene, polypropylene, polyvinylidenefluoride, polytetrafluoroethylene, poly(4-methyl 1-pentene) and especially polyacrylonitrile.

One may use a commercially available porous sheet material as the support, if desired. Alternatively one may prepare the porous support using techniques generally known in the art for the preparation of microporous materials.

One may also use a porous support which has been subjected to a corona discharge treatment, glow discharge treatment, flame treatment, ultraviolet light irradiation treatment or the like, e.g. for the purpose of improving its wettability and/or adhesiveness.

The porous support preferably possesses pores which are as large as possible, consistent with providing a smooth surface for the gutter layer.

The porous support preferably has an average pore size of at least about 50% greater than the average pore size of the discriminating layer, more preferably at least about 100% greater, especially at least about 200% greater, particularly at least about 1000% greater than the average pore size of the discriminating layer.

The pores passing through the porous support typically have an average diameter of 0.001 to 10 μm, preferably 0.01 to 1 μm. The pores at the surface of the porous support typically have a diameter of 0.001 to 0.1 μm, preferably 0.005 to 0.05 μm. The pore diameter may be determined by, for example, viewing the surface of the porous support before it is converted to the membrane by scanning electron microscopy (“SEM”) or by cutting through the support and measuring the diameter of the pores within the porous support, again by SEM.

The porosity at the surface of the porous support may also be expressed as a % porosity, i.e.

$$\% porosity = \frac{100 \% \times ( area of the surface which is missing due to pores )}{( total surface area )}$$

The areas required for the above calculation may be determined by inspecting the surface of the porous support by SEM. Thus, in a preferred embodiment, the porous support has a % porosity >1%, more preferably >3%, especially >10%, more especially >20%.

The porosity of the porous support may also be expressed as a CO₂ gas permeance (units are m³(STP)/m²·s·kPa). When the membrane is intended for use in gas separation the porous support preferably has a CO₂ gas permeance of 5 to 150×10⁻⁵ m³(STP)/m²·s·kPa, more preferably of 5 to 100×10⁻⁵ m³(STP)/m²·s·kPa, most preferably of 7 to 70×10⁻⁵ m³(STP)/m²·s·kPa.

Alternatively the porosity may be characterised by measuring the N₂ gas flow rate through the porous support. Gas flow rate can be determined by any suitable technique, for example using a Porolux™ 1000 device, available from Porometer.com. Typically the Porolux™ 1000 is set at the maximum pressure (about 34 bar) and one measures the flow rate (L/min) of N₂ gas through the porous support under test. The N₂ flow rate through the porous support at a pressure of about 34 bar for an effective sample area of 2.69 cm² (effective diameter of 18.5 mm) is preferably >1 L/min, more preferably >5 L/min, especially >10 L/min, more especially >25 L/min. The higher of these flow rates are preferred because this reduces the likelihood of the gas flux of the resultant membrane being reduced by the porous support.

The above pore sizes and porosities refer to the porous support before it has been converted into the composite membrane of the present invention.

The porous support preferably has an average thickness of 20 to 500 μm, preferably 50 to 400 μm, especially 100 to 300 μm.

Optionally the composite membrane of the invention comprises a gutter layer, typically located on and in contact with the porous support. The gutter layer (when present) performs the function of providing a smooth and continuous surface for a discriminating layer.

The gutter layer preferably has an average thickness 25 to 1200 nm, preferably 30 to 800 nm, especially 50 to 650 nm, e.g. 70 to 120 nm, 130 to 170 nm, 180 to 220 nm, 230 to 270 nm, 300 to 360 nm, 380 to 450 nm, 470 to 540 nm or 560 to 630 nm.

The thickness of the gutter layer, discriminating layers and the non-discriminating layer may be determined by cutting through the membrane and examining its cross section by SEM. The part of the gutter layer which is present within the pores of the support is not taken into account.

The gutter layer is preferably non-porous, i.e. any pores present therein have an average diameter <1 nm, although it is gas permeable and usually has low or no ability to discriminate between gases, allowing polar and non-polar gases to flow therethrough at substantially the same flow rate.

Preferably the gutter layer comprises silicon atoms, e.g. the gutter layer is or comprises an Si-containing polymer. Preferably the gutter layer comprises siloxane groups, e.g. the gutter layer is or comprises a polymer comprising siloxane groups, especially dialkylsiloxane groups. Dialkylsiloxane groups may be incorporated into the gutter layer by using a polymerisable dialkylsiloxane as one of the components of a curable composition for forming the gutter layer. The polymerisable dialkylsiloxane (which may alternatively be referred to as a polymerisable compound comprising dialkylsiloxane groups) is optionally a monomer having a dialkylsiloxane group or a polymerisable oligomer or polymer having dialkylsiloxane groups. For example, one may prepare the gutter layer from a radiation-curable composition containing a partially crosslinked, radiation-curable polymer comprising dialkylsiloxane groups, as described in more detail below. Typical dialkylsiloxane groups are of the formula —{O—Si(CH₃)₂}n wherein n is at least 1, e.g. 1 to 100. Poly(dialkylsiloxane) compounds having terminal vinyl groups are also available and these may be incorporated into the gutter layer by a polymerisation processes.

In one embodiment the gutter layer does not contain Sb and Ti in a molar ratio of 0.41. More preferably the gutter layer does not contain Sb and Ti in a molar ratio from 0.40 to 0.42.

Preferably the gutter layer comprises groups of formula —O—CO—(CH₂)ₙ—Si—C(OR¹)₂— wherein n is from 1 to 3 (preferably 2) and R¹ is C₁₋₄-alkyl (preferably methyl). Such groups may be incorporated into the gutter layer through the use of appropriate monomers, for example monomers comprising two groups of formula HO₂C—(CH₂)ₙ—Si—C(OR¹)₂— (wherein n and R¹ are as hereinbefore defined). Such monomers can act as crosslinking agents for polyepoxy compounds and are commercially available, for example X-22-162C from Shin-Etsu Chemical Co.

Irradiation of a curable composition (sometimes referred to as “curing” in this specification) to form the gutter layer may be performed using any source which provides the wavelength and intensity of radiation necessary to cause the radiation-curable composition to polymerise and thereby form the gutter layer on the porous support. For example, electron beam, ultraviolet (UV), visible and/or infra red radiation may be used to irradiate (cure) the radiation-curable composition, with the appropriate radiation being selected to match the components of the composition. Preferably irradiation of a radiation-curable composition used to form the gutter layer begins within 7 seconds, more preferably within 5 seconds, most preferably within 3 seconds, of the radiation-curable composition being applied to the porous support.

Suitable sources of UV radiation include mercury arc lamps, carbon arc lamps, low pressure mercury lamps, medium pressure mercury lamps, high pressure mercury lamps, swirlflow plasma arc lamps, metal halide lamps, xenon lamps, tungsten lamps, halogen lamps, lasers and ultraviolet light emitting diodes. Particularly preferred are UV emitting lamps of the medium or high pressure mercury vapour type. In addition, additives such as metal halides may be present to modify the emission spectrum of the lamp. In most cases lamps with emission maxima between 200 and 450 nm are particularly suitable.

The energy output of the irradiation source is preferably from 20 to 1000 W/cm, preferably from 40 to 500 W/cm but may be higher or lower as long as the desired exposure dose can be realized.

Optionally one may apply a radiation curable composition to the porous support, then irradiate the radiation curable composition to form the gutter layer and then apply the discriminating layer thereto. Alternatively, one may apply the radiation-curable composition to the porous support and apply the discriminating layer (or the chemicals used to prepare the discriminating layer) on top of the radiation-curable composition and then perform the irradiation step for both layers simultaneously.

In order to produce a sufficiently flowable composition for use in a high speed coating machine, the radiation-curable composition used to form the gutter layer preferably has a viscosity below 4000 mPa·s when measured at 25° C., more preferably from 0.4 to 1000 mPa·s when measured at 25° C. Most preferably the viscosity of the radiation-curable composition is from 0.4 to 500 mPa·s when measured at 25° C. For coating methods such as slide bead coating the preferred viscosity is from 1 to 100 mPa·s when measured at 25° C. The desired viscosity is preferably achieved by controlling the amount of solvent in the radiation-curable composition and/or by appropriate selection of the components of the radiation-curable composition and their amounts.

In the multi-layer coating methods mentioned above, one may optionally apply a lower inert solvent layer to the porous support followed by applying the radiation-curable composition used to form the gutter layer.

With suitable coating techniques, coating speeds of at least 5 m/min, e.g. at least 10 m/min or even higher, such as 15 m/min, 20 m/min, or even up to 100 m/min, can be reached. In a preferred embodiment the radiation-curable composition (and also the discriminating layer and protective layer, when present) is applied to the support at one of the aforementioned coating speeds.

The thickness of the gutter layer on the support may be influenced by controlling the amount of curable composition per unit area applied to the support. For example, as the amount of curable composition per unit area increases, so does the thickness of the resultant gutter layer. The same principle applies to formation of the discriminating layer and protective layer, when present.

While it is possible to prepare the membranes of the invention on a batch basis with a stationary porous support, it is much preferred to prepare them on a continuous basis using a moving porous support, e.g. the porous support may be in the form of a roll which is unwound continuously or the porous support may rest on a continuously driven belt. Using such techniques the radiation-curable composition can be applied to the porous support on a continuous basis or it can be applied on a large batch basis. Removal of any inert solvent present in the radiation-curable composition can be accomplished at any stage after the radiation-curable composition has been applied to the support, e.g. by evaporation.

In one embodiment the gutter layer is an activated gutter layer. By using an activated gutter layer one may achieve a good coverage of the discriminating layer on the surface of the gutter layer. The gutter layer may be activated by treating the gutter layer with, or exposing it to, a high energy species, for example species such as radicals, ions and/or molecules in an excited state. The gutter layer is preferably activated by a process comprising corona treatment, plasma treatment (e.g. at atmospheric or reduced pressure), flame treatment and/or ozone treatment. For the corona or plasma treatment generally an energy dose of 0.5 to 100 kJ/m2 will be sufficient, for example about 1, 3, 5, 8, 15, 25, 45, 60, 70 or 90 kJ/m2. Suitable methods for activating the gutter layer include those described for polymers in Chapter 6 of the book entitled “Polymer surfaces From Physics to Technology”, revised and updated edition 1998, by Fabio Garbassi, Marco Morra and Ernesto Occhiello (Publisher: John Wiley & Sons).

Typically discriminating layers are layers are capable of selectively allowing some gases to pass more easily therethrough than others. The discriminating layers preferably each independently have a CO₂/CH₄ selectivity of at least 3 and/or a gas flux (Qᵢ) for CO₂ of 10 to 800 gas permeation units (GPU). The gas flux (Qᵢ) and selectivity (α_{CO2/CH4}) may be measured by the techniques described in the Examples section below.

The first discriminating layer is closer to the porous support than the outermost layer (E).

The discriminating layers optionally have the same chemical composition as each other or the discriminating layers may have chemical compositions which are different to each other.

Typically the first discriminating layer is present on (in direct contact with) the gutter layer, when present, or on (in direct contact with) the porous support when the composite membrane does not comprise a gutter layer.

The outermost layer is a discriminating layer comprising a polyimide polymer. Thus the composite membrane typically comprises two faces, the first face being the porous support (A) and the second face being the outermost discriminating layer (D).

The amount polyimide polymer present in the outermost layer (D) is preferably at least 5 wt %, more preferably at least 10 wt %, especially at least 25 wt %, more especially at least 50 wt % and particularly at least 75 wt %. The amount of polyimide polymer present in the outermost layer (D) is preferably up to 100%, i.e. the outermost layer (D) preferably consists essentially of polyimide polymer.

Thus in preferred embodiments the outermost layer (D) comprises 5 to 100 wt %, 10 to 100 wt %, 25 to 100 wt %, 50 to 100 wt % or 75 to 100 wt % polyimide polymer. The desired amount of polyimide polymer present in the outermost layer (D) may be provided by using a formulation to make that layer comprising the desired amount of polyimide polymer or polymer-forming components relative to the any other polymer or polymer-forming components. When calculating the wt % of polyimide polymer present in the outermost layer (D) one ignores any merging between the outermost layer and the non-discriminating layer (E) during preparation of the composite membrane.

Typically the discriminating layers are each independently cross-linked polymer layers, preferably comprising a polyimide, cellulose acetate, polyethyleneoxide, polyamide, polystyrene, polysulphone, polyether ketone (PEEK), polyethylene glycol (PEG) or polyetherimide or a combination of two or more thereof, provided that the outermost layer (D) is a discriminating layer comprising or consisting of a polyimide polymer.

Preferably one or both of discriminating layers contain amine groups and/or silicon atoms. One may prepare a discriminating layer containing amine groups by including an amine in the ingredients used to form the discriminating layer. Suitable amines include tertiary, secondary and preferably primary amines, especially primary alkylamines. Thus the discriminating layers preferably comprise one or more amines.

Still further, preferably one or both of the discriminating layers comprises —CF₃ groups.

Preferably both of the discriminating layers comprise a polymer, for example a polyimide, especially a polyimide comprising trifluoromethyl groups and optionally carboxylic acid groups.

In one embodiment, both of the discriminating layers comprise imide groups and the non-discriminating layer is free-from imide groups.

In another embodiment, one or both of the discriminating layers comprise cellulose acetate and the non-discriminating layer is free-from cellulose acetate.

Preferably the non-discriminating layer is free-from imide groups and free-from cellulose acetate.

Preferably one or both of the discriminating layers comprises polymer comprising groups of the Formula (1) wherein Ar is an aromatic group and R is a pendant carboxylic acid group, a sulphonic acid group, a hydroxyl group, a thiol group, an epoxy group or an oxetane group:

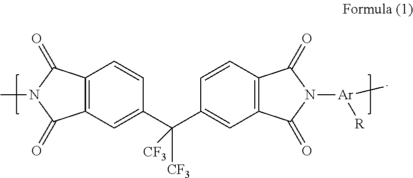

Preferably R in Formula (1) is a carboxylic acid group, which may be in the free acid or salt form.

The discriminating layers preferably each independently have an average thickness of 20 nm to 2 μm, more preferably 30 nm to 1 μm, especially 40 to 200 nm.

The non-discriminating layer (i.e. E) typically performs the function of providing a scratch- and crack-resistant layer on top of the first discriminating layer and/or sealing any defects present in the first discriminating layer.

The non-discriminating layer preferably has an average thickness 50 to 800 nm, preferably 150 to 600 nm, especially 200 to 700 nm, more especially 210 to 650 nm, e.g. 230 to 270 nm, 300 to 360 nm, 380 to 450 nm, 470 to 540 nm or 560 to 630 nm.

The non-discriminating layer preferably has a CO₂/CH₄ selectivity of less than 3 and/or a gas flux (Qᵢ) for CO₂ of 900 to 3000 gas permeation units (GPU). The gas flux (Qᵢ) and selectivity (α_{CO2/CH4}) may be measured by the techniques described in the Examples section below.

The non-discriminating layer preferably comprises pores of average diameter <1 nm.

Preferably at least 90% of the surface area of the non-discriminating layer is in contact with the said discriminating layers.

In a preferred embodiment both the gutter layer and the non-discriminating layer are obtained from curable compositions which comprise the same components. This leads to efficiencies in manufacturing and raw material costs. Preferably the amount of each component used to make the non-discriminating layer is within at most 10%, more preferably within at most 5%, of the amount of the same component used to make the gutter layer. For example, if the gutter layer comprises 30 wt % of a particular component, then preferably the non-discriminating layer comprises 27 to 33 wt % (i.e. +/−10%), more preferably 28.5 wt % to 31.5 wt % (i.e. +/−5%), of that same component.

In another embodiment the non-discriminating layer comprises a polyamine and the first discriminating layer comprises carboxylic acid groups. This embodiment is preferred because the attraction between the amine groups in the polyamine and the carboxylic acid groups can enhance the adhesion of the non-discriminating layer to the discriminating layer.

Thus the composite gas separation membrane according to the invention is preferably prepared in such a way that carboxylic acid groups present in the discriminating layers are reacted with amine groups present in the non-discriminating layer. Such a reaction may be performed under mild conditions if desired. Typically, when the non-discriminating layer comprises a polyamine and a discriminating layer comprises carboxylic acid groups, the composite membrane is heated in order to form non-covalent bonds between the amine groups of the polyamine and the carboxylic acid groups, e.g. to a temperature of up to 49° C., more preferably up to 45° C., especially at temperature in the range 5 to 40° C., more especially 10 to 30° C.

The gutter layer and the non-discriminating layer are preferably each independently obtained from a curable composition comprising:
(1) 0.5 to 25 wt % of radiation-curable component(s), at least one of which comprises dialkylsiloxane groups;
(2) 0 to 5 wt % of a photo-initiator;
(3) 70 to 99.5 wt % of inert solvent; and
(4) 0.01 to 5 wt % of metal complex.

Preferably the curable composition has a molar ratio of metal:silicon of at least 0.0005.

Preferably the composition (and the resultant gutter layer and non-discriminating layer) has a molar ratio of metal:silicon of 0.001 to 0.1, more preferably 0.003 to 0.03.

Preferably the radiation-curable composition used to form the non-discriminating layer and/or gutter layer comprises 0.02 to 0.6 mmol (more preferably 0.03 to 0.3 mmol) of component (4) per gram of component (1).

The radiation-curable component(s) of component (1) typically comprise at least one radiation-curable group. Radiation curable groups include ethylenically unsaturated groups (e.g. (meth)acrylic groups (e.g. CH₂═CR₁C(O)— groups), especially (meth)acrylate groups (e.g. CH₂═CR₁C(O)O— groups), (meth)acrylamide groups (e.g. CH₂═CR₁C(O)NR₁— groups), wherein each R₁ independently is H or CH₃) and especially oxetane or epoxide groups (e.g. glycidyl and epoxycyclohexyl groups).

The amount of radiation-curable component(s) present in the radiation-curable composition (i.e. component (1)) is preferably 1 to 20 wt %, more preferably 2 to 15 wt %. In a preferred embodiment, component (1) of the radiation-curable composition comprises a partially crosslinked, radiation-curable polymer comprising dialkylsiloxane groups.

Photo-initiators may be included in the radiation-curable composition and are usually required when the curing uses UV radiation. Suitable photo-initiators are those known in the art such as radical type, cation type or anion type photo-initiators.

Cationic photo-initiators are preferred when the radiation-curable component(s) comprises curable groups such as epoxy, oxetane, other ring-opening heterocyclic groups or vinyl ether groups.

Preferred cationic photo-initiators include organic salts of non-nucleophilic anions, e.g. hexafluoroarsinate anion, antimony (V) hexafluoride anion, phosphorus hexafluoride anion, tetrafluoroborate anion and tetrakis(2,3,4,5,6-pentafluorophenyl)boranide anion. Commercially available cationic photo-initiators include UV-9380c, UV-9390c (manufactured by Momentive performance materials), UVI-6974, UVI-6970, UVI-6990 (manufactured by Union Carbide Corp.), CD-1010, CD-1011, CD-1012 (manufactured by Sartomer Corp.), Adekaoptomer™ SP-150, SP-151, SP-170, SP-171 (manufactured by Asahi Denka Kogyo Co., Ltd.), Irgacure™ 250, Irgacure™ 261 (Ciba Specialty Chemicals Corp.), CI-2481, CI-2624, CI-2639, CI-2064 (Nippon Soda Co., Ltd.), DTS-102, DTS-103, NAT-103, NDS-103, TPS-103, MDS-103, MPI-103 and BBI-103 (Midori Chemical Co., Ltd.). The above mentioned cationic photo-initiators can be used either individually or in combination of two or more.

Radical Type I and/or type II photo-initiators may also be used when the curable group comprises an ethylenically unsaturated group, e.g. a (meth)acrylate or (meth)acrylamide.

Examples of radical type I photo-initiators are as described in WO 2007/018425, page 14, line 23 to page 15, line 26, which are incorporated herein by reference thereto.

Examples of radical type II photo-initiators are as described in WO 2007/018425, page 15, line 27 to page 16, line 27, which are incorporated herein by reference thereto.

The amount of photo-initiator present in the radiation-curable composition (i.e. component (2)) is preferably 0.005 to 2 wt %, more preferably 0.01 to lwt %.

Preferably the weight ratio of component (2) to (1) in the radiation-curable composition is between 0.001 and 0.2 to 1, more preferably between 0.002 and 0.1 to 1. A single type of photo-initiator may be used but also a combination of several different types.

When no photo-initiator is included in the radiation-curable composition, the composition can be advantageously cured by electron-beam exposure. Preferably the electron beam output is between 50 and 300 keV. Curing can also be achieved by plasma or corona exposure.

The function of the inert solvent (3) is to provide the radiation-curable composition with a viscosity suitable for the particular method used to apply the curable composition to the support. For high speed application processes one will usually choose an inert solvent of low viscosity. Examples of suitable inert solvents are mentioned above in relation to preparation of the PCP Polymer.

The amount of inert solvent present in the radiation-curable composition (i.e. component (3)) is preferably 70 to 99.5 wt %, more preferably 80 to 99 wt %, especially 90 to 98 wt %.

Inert solvents are not radiation-curable.

The metal complex included in the radiation-curable composition as component (4) can provide the necessary metal in that composition and in the protective layer.

The metal is preferably selected from the groups 2 to 16 of the periodic table (according the IUPAC format), including transition metals. Examples of such metals include: Be, Mg, Ca, Sr, Ba, Sc, Y, La, Ce, Pr, Nd, Pm, Sm, Eu, Gd, Tb, Dy, Ho, Er, Tm, Yb, Lu, Ti, Zr, Hf, V, Nb, Ta, Cr, Mo, W, Mn, Re, Fe, Ru, Os, Co, Rh, Ir, Ni, Pd, Pt, Cu, Zn, Cd, B, Al, Ga, In, TI, Si, Ge, Sn, Pb, As, Sb, Bi, Se, Te. More preferred are Mg, Ca, Sr, Ba, Sc, Y, La, Ce, Pr, Nd, Sm, Gd, Dy, Ho, Er, Tm, Yb, Ti, Zr, Hf, V, Nb, Ta, Cr, Mo, W, Mn, Fe, Ru, Co, Ir, Ni, Zn, B, Al, Ga, In, Si, Ge, Sn, As, Sb, Bi, Se and Te and mixtures comprising two or more thereof (the phrase “a metal” is not intended to be limited to just one metal and includes the possibility of two or more metals being present). Preferably the metal is not platinum.

From commercial availability point of view, metals from the groups 3, 4, 13 and/or 14 of the periodic table are preferred, more preferably Ti, Zr, Al, Ce and Sn, especially Ti, Zr and Al.

The metal preferably has a positive charge of at least two, more preferably the metal is trivalent (charge of 3⁺), tetravalent (charge of 4⁺) or pentavalent (charge of 5⁺).

The metal complex, when used, may also comprise two or more different metal ions, e.g. as in barium titanium alkoxide, barium yttrium alkoxide, barium zirconium alkoxide, aluminum yttrium alkoxide, aluminum zirconium alkoxide, aluminum titanium alkoxide, magnesium aluminum alkoxide and aluminum zirconium alkoxide,

The metal complex preferably comprises a metal (e.g. as described above) and a halide or an organic ligand, for example an organic ligand comprising one or more donor atoms which co-ordinate to the metal. Typical donor atoms are oxygen, nitrogen and sulphur, e.g. as found in hydroxyl, carboxyl, ester, amine, azo, heterocyclic, thiol, and thioalkyl groups.

The ligand(s) may be monodentate or multidentate (i.e. the ligand has two or more groups which co-ordinate with the metal).

In a particularly preferred embodiment the metal complex comprises a metal and an organic ligand comprising an alkoxide or an optionally substituted 2,4-pentanedionate group and/or a carboxyl group (e.g. a neodecanoate group).

The metal complex may also comprise one or more inorganic ligands, in addition to the organic ligand(s), and optionally one or more counterions to balance the charge on the metal. For example the metal complex may comprise a halide (e.g. chloride or bromide) or water ligand.

Preferably the metal complex has a coordination number of 2 to 6, more preferably 4 to 6 and especially 4 or 6.

Preferably the curable composition comprises 0.01 to 5 wt %, more preferably 0.01 to 2 wt %, especially 0.02 to 1 wt % of metal complex.

The curable composition may contain other components, for example surfactants, surface tension modifiers, viscosity enhancing agents, biocides and/or other components capable of co-polymerisation with the other ingredients.

In a preferred embodiment, the first and second discriminating layers comprise the same components. This leads to efficiencies in manufacturing and raw material costs. Preferably the amount of each component used to make the second discriminating layer is within at most 10%, more preferably within at most 5%, of the amount of the same component used to make the first discriminating layer.

Surprisingly the composite membranes of the present invention comprising (C), (D) and (E) have particularly good flux rates, e.g. as compared to composite membranes comprising only one discriminating layer.

According to a second aspect of the present invention there is provided a process for preparing a composite membrane comprising the steps:
(i) optionally applying a gutter layer (B) to a porous support; and
(ii) applying to the support, or to the gutter layer when present, a first discriminating layer (C), a non-discriminating layer (E) and an outermost discriminating layer (D) comprising a polyimide polymer, in the order (C), (E), (D) wherein layer (C) is closest to the support and layer (D) is furthest away from the support.

By performing the process of the second aspect of the present invention such that the first discriminating layer (C), the non-discriminating layer (E) and the outermost discriminating layer (D) are applied in the order (C), (E), (D) one may ensure that the non-discriminating layer is interposed between the first and outermost discriminating layers.

Thus in a preferred process for making the membranes of the invention, the layers (B) (when desired), (C), (E) and (D) are applied continuously to the porous support by means of a manufacturing unit comprising station(s) for applying curable compositions to a porous support which, when cured or dried, provide the layers (B) (when desired), (C), (E) and (D) in that order wherein (C) is closest to the support and (D) is furthest away from the support.

Suitable compositions for providing the optional gutter layer (B) and the non-discriminating (E) are as hereinbefore described. Suitable compositions for providing the discriminating layers ((C) and (D)) comprise one or more of the cross-linked polymers mentioned above in relation to the discriminating layer together with one or more solvents for the cross-linked polymer(s).

The manufacturing unit optionally comprises an irradiation source located downstream from the station(s) for applying curable compositions to a porous support. The manufacturing unit optionally further comprises a means for moving the porous support and optionally a means for activating the gutter layer or porous support (e.g. a source of high energy species such as plasma) One may apply the first discriminating layer (C), the non-discriminating layer (E) and the outermost discriminating layer (D) using the methods described above in relation to application of the optional gutter layer, especially multi-layer coating methods. Typically, however, one will select the coating conditions such that the discriminating layers are much thinner than the gutter layer and the non-discriminating layers. For example one may apply to the gutter layer a much thinner coating of a composition which forms the discriminating layer than was used to form the gutter layer.

In the composite membrane and the process of the present invention, the outermost discriminating layer is an outmost layer of the composite membrane (i.e. the layer which is furthest away from the porous support). The composite membrane is free from layers which are further away from the porous support than the outermost discriminating layer. For example, the composite membrane is free from a non-discriminating protective outermost layer.

According to a third aspect of the present invention there is provided a gas separation cartridge comprising a composite membrane according to the first aspect of the present invention.

According to a fourth aspect of the present invention there is provided a gas separation module for separating a feed gas containing a target gas into a gas stream rich in the target gas and a gas stream depleted in the target gas, the module comprises a housing and one or more cartridges according to third aspect of the present invention.

According to a fourth aspect of the present invention there is provided a method for separating a feed gas containing a target gas into a gas stream rich in the target gas and a gas stream depleted in the target gas, which method comprises contacting the feed gas with a membrane according to first aspect of the present invention, or using a gas separation cartridge according to the third aspect of the present invention and/or a gas separation module according to the fourth aspect of the present invention, and collecting the gas which passes through the membrane and/or the gas which does not pass through the membrane.

The following materials were used in the Examples (all without further purification):
PAN is a porous support (polyacrylonitrile L10 ultrafiltration membrane from GMT Membrantechnik GmbH, Germany).
HI is a non-woven porous support Hi-star 05TH-100 of thickness 150 μm from Hirose paper MFG Co. Ltd.
X-22-162C is a dual end reactive silicone having carboxylic acid reactive groups, a viscosity of 220 mm²/s and a reactive group equivalent weight of 2,300 g/mol] from Shin-Etsu Chemical Co., Ltd. (MWT 4,600)

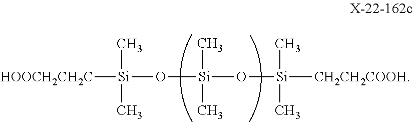

DBU is 1,8-diazabicyclo[5.4.0]undec-7-ene from Sigma Aldrich.
UV9300 is SilForce™ UV9300 from Momentive Performance Materials Holdings having an epoxy equivalent weight of 950 g/mole oxirane (MWT 9,000, determined by viscometry).
UV9390C is SilForce™ UV-9390C from Momentive Performance Materials Holdings.
Ti(OiPr)₄ is titanium (IV) isopropoxide from Sigma Aldrich.
n-heptane is n-heptane from Brenntag Nederland BV.
MEK is 2-butanone from Brenntag Nederland BV.
MIBK is methylisobutyl ketone from Brenntag Nederland BV.
APTMS is 3-trimethoxysilyl propan-1-amine from Sigma Aldrich.
THF is tetrahydrofuran from Brenntag Nederland BV.
PI1: is 6FDA-TeMPDₓ/DABA_{y}, x/y=20/80; obtained from FUJIFILM Corporation, having the following structure:

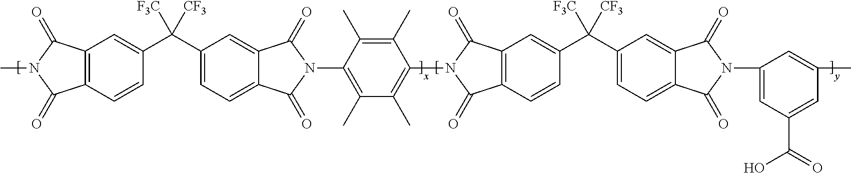

PI2: is 6FDA-TeMPD; obtained from FUJIFILM Corporation, having the following structure:

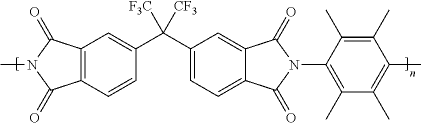

CA is cellulose acetate CA-398-3 from Eastman Chemicals.

### Evaluation of Gas Flux and Selectivity

### (A) Gas Flux

The flux of CH₄ and CO₂ through the composite membranes was measured at 40° C. and gas feed pressure of 6000 kPa using a gas permeation cell with a measurement diameter of 3.0 cm and a feed gas composition of 13 v/v % CO₂ and 87 v/v % CH₄.

The flux of each gas was calculated based on the following equation:

Qᵢ=(θ_{Perm}·X_{Perm,i})/(A·(P_{Feed}·X_{Feed,I}−P_{Perm}·X_{Perm,i}))

wherein:

Qᵢ=Flux of each gas (m³(STP)/m² kPa·s)

θ_{Perm}=Permeate flow (m³(STP)/s)

X_{Perm,I}=Volume fraction of each gas in the permeate

A=Membrane area (m²)

P_{Feed}=Feed gas pressure (kPa)

X_{Feed,i}=Volume fraction of each gas in the feed

P_{Perm}=Permeate gas pressure (kPa)

STP is standard temperature and pressure, which is defined here as 25.0° C. and 1 atmosphere (101.325 kPa).

### (B) Selectivity

The selectivity (α_{CO2/CH4}) for the composite membranes was calculated from Q_{CO2} and Q_{CH4} calculated above, based on following equation:

(α_{CO2/CH4}=Q_{CO2}/Q_{CH4}

### EXAMPLES

### 1. Preparation of Compositions Used to Form the Layers

### 1.1 Preparation of Composition RCC1 Used to Form the Gutter Layer and the Non-Discriminating Layer

### 1.1.1 Step 1

The components UV9300, X-22-162C and DBU in the amounts indicated in Table 1 were dissolved in n-heptane and maintained at a temperature of 95° C. for 168 hours to form a solution of a partially cured polymer (PCP Polymer) having a viscosity of 22.8 mPas at 25.0° C.

TABLE 1
Preparation of the PCP Polymer

| | Ingredient | Amount (wt %) |
|---|---|---|
| Preparation of the PCP Polymer | UV9300 | 39.078 |
| | X-22-162C | 10.789 |
| | DBU | 0.007 |
| | n-Heptane | 50.126 |

### 1.1.2 Step 2) Preparation of Radiation-Curable Compositions

The solution of PCP Polymer described prepared in Step 1) was cooled to 20° C. and diluted using n-heptane to the PCP Polymer concentration of 5 wt %. The solution was then filtered through a filter paper having a pore size of 2.7 μm and photoinitiator UV9390C and a metal complex (Ti(OiPr)₄) were then added in the amounts indicated in Table 1 to give radiation-curable composition RCC1.

TABLE 2
Preparation of the Radiation-curable Composition

| | Ingredient | Amount (wt %) |
|---|---|---|
| Preparation of radiation- | PCP Polymer concentration | 5.00 |
| curable composition | in curable composition | |
| | UV9390c | 0.10 |
| | Ti(OiPr)₄ | 0.1 |

The gutter layers and non-discriminating layers obtained from compositions RCC1 are abbreviated in Table 4 below as “GL” and “NDL” respectively.

### 1.2 Preparation of Compositions DLC1 to DLC3 Used to Form the Discriminating Layers

The components indicated in Table 3 below were mixed to provide compositions DLC1 to DLC3:

TABLE 3

| Ingredient (wt %) | DLC1 | DLC2 | DLC3 |
|---|---|---|---|
| PI1 | 1.50 | — | — |
| PI2 | — | 1.50 | — |
| CA | — | — | 2.0 |
| MIBK | 4.515 | 4.515 | — |
| THF | 7.485 | 7.485 | — |
| MEK | 86.50 | 86.50 | — |
| Acetone | 0 | 0 | 69.5 |
| Formamide | 0 | 0 | 19.0 |
| Maleic acid | 0 | 0 | 9.5 |

The discriminating layers obtained from compositions DLC1, DLC2 and DLC3 are abbreviated in Table 4 below as “DL1”, “DL2” and “DL3” respectively.

### 2. Preparation of Composite Membranes

### 2.1 General Method Used for Applying a Gutter Layers to the Porous Support

The radiation-curable composition RCC1 was applied to a porous support (PAN) by spin coating, cured using a Light Hammer LH10 from Fusion UV Systems fitted with a D-bulb with an intensity of 24 kW/m and then dried. The thickness of the resultant gutter layer was 600 nm. The resultant gutter layer was activated by treatment with a corona discharge under an atmosphere of air, using a Softal™ corona VTG250 apparatus at a specific energy of 16 J/cm² using ceramic electrodes coupled to a Softal™ VTG3005 generator

### 2.2 General Methods Used for Applying Discriminating Layers

### 2.2.1 DL Method 1

The composition used to form the discriminating layer was applied to the underlying porous support or layer (as the case may be) by spin coating to form discriminating layer of thickness 90 nm.

### 2.2.2 DL Method 2 (Performed Directly on the Porous Support)

The composition used to form the discriminating layer was applied directly to the porous support (i.e. with no intervening no gutter layer or other layers) using a blade coater to form a layer of thickness 0.1 mm. The solvent was then evaporated from the composition (for 18 seconds) to give a discriminating layer of thickness 2 μm.

### 2.3 General Method Used for Applying the Non-Discriminating Layers

The non-discriminating layers were applied to the underlying layer by spin coating, curing and activation using the general method described at point 2.1 above.

The thickness of each non-discriminating layer was 600 nm in each case.

Examples 1 to 3 of the invention and Comparative Examples 1 to 7 were prepared as indicated in Table 4 below:

TABLE 4

| | | | | | | | | CEx5 | | |
|---|---|---|---|---|---|---|---|---|---|---|
| | | | | | | | CEx4 | (2 DL, but | | CEx7 |
| | | | | | | CEx3 | (2 DL, but | the outermost | CEx6 | (1 DL, |
| | | | | CEx1 | CEx2 | (only 1 | DL not the | layer is not a | (Outermost | 1 NDL, no |
| | | | | (only | (only | DL and 1 | outermost | discriminating | DL but | outermost |
| | Ex1 | Ex2 | Ex3 | 1 DL) | 1 DL) | NDL) | layer) | layer) | no NDL) | DL |
| Composition | RCC1 | RCC1 | NA | RCC1 | RCC1 | RCC1 | RCC1 | RCC1 | NA | NA |
| used to form | | | | | | | | | | |
| the gutter | | | | | | | | | | |
| layer | | | | | | | | | | |
| Composition | DLC1 | DLC2 | DLC3 | DLC1 | DLC2 | DLC1 | DLC1 | DLC2 | DLC3 | DLC3 |
| used to form | | | | | | | | | | |
| the first dis- | | | | | | | | | | |
| criminating | | | | | | | | | | |
| Layer | | | | | | | | | | |
| Method Used | Method | Method | Method | Method | Method | Method | Method | Method | Method | Method |
| to form the | 1 | 1 | 2 | 1 | 1 | 1 | 1 | 1 | 2 | 2 |
| first dis- | | | | | | | | | | |
| criminating | | | | | | | | | | |
| Layer | | | | | | | | | | |
| Radiation- | RCC1 | RCC1 | RCC1 | NA | NA | RCC1 | RCC1 | RCC1 | NA | RCC1 |
| curable | | | | | | | | | | |
| composition | | | | | | | | | | |
| used to form | | | | | | | | | | |
| the NDL | | | | | | | | | | |
| Composition | DLC1 | DLC2 | DLC3 | NA | NA | NA | DLC1 | DLC2 | NA | NA |
| used to form | | | | | | | | | | |
| the second DL | | | | | | | | | | |
| Method used | Method | Method | Method | NA | NA | NA | Method | Method | NA | NA |
| to form the | 1 | 1 | 2 | | | | 1 | 1 | | |
| second DL | | | | | | | | | | |
| Layers in | PAN/ | PAN/ | HI/ | PAN/ | PAN/ | PAN/ | PAN/ | PAN/ | HI/ | HI/ |
| resultant | GL/ | GL/ | DL3/ | GL/ | GL/ | GL/ | GL/ | GL/ | DL3 | DL3/ |
| membrane | DL1/ | DL2/ | NDL/ | DL1 | DL2 | DL1/ | DL1/ | DL2/ | | NDL |
| | NDL/ | NDL/ | DL3 | | | NDL | NDL/ | NDL/ | | |
| | DL1 | DL2 | | | | | DL1/ | DL2/ | | |
| | | | | | | | NDL | NDL | | |
| Gas flux of | 85 | 80 | 110 | 45 | 47 | 45 | 47 | 47 | 80 | 80 |
| resultant | | | | | | | | | | |
| membrane | | | | | | | | | | |
| (GPU) | | | | | | | | | | |
| Selectivity | 24 | 23 | 11 | 30 | 28 | 28 | 22 | 22 | 15 | 15 |
| of resultant | | | | | | | | | | |
| Membrane | | | | | | | | | | |
| (α_{CO2/CH4}) | | | | | | | | | | |

Notes of Table 4:
1. “GL” is an abbreviation for “gutter layer”, “DL” is an abbreviation for “discriminating layer” and “NDL” is an abbreviation for “non- discriminating layer”. “Ex” is an abbreviation for Example and “CEx” is an abbreviation for Comparative Example.
2. The outermost layers in CEx4 and CEx5 are not DLs. Instead, the outermost layers were non-discriminating layers applied by Method 1.
3. “NA” means not applicable.

1. A composite membrane comprising:
(A) a porous support;
(B) optionally a gutter layer;
(C) a first discriminating layer;
(D) an outermost layer; and
(E) a non-discriminating layer interposed between the first discriminating layer (C) and the outermost layer (D);
wherein the outermost layer (D) is a discriminating layer comprising a polyimide polymer.

2. The composite membrane according to claim 1 wherein the outermost layer (D) comprises 5 to 100 wt % polyimide polymer.

3. The composite membrane according to claim 1 wherein the outermost layer (D) comprises 50 to 100 wt % polyimide polymer.

4. The composite membrane according to claim 1 wherein the non-discriminating layer comprises siloxane groups.

5. The composite membrane according to claim 1 wherein the non-discriminating layer has a CO2/CH4 selectivity of less than 3.

6. The composite membrane according to claim 1 wherein the discriminating layers have a CO2/CH4 selectivity of more than 3.

7. The composite membrane according to claim 1 wherein the discriminating layers each comprise —CF3 groups and the non-discriminating layer is free from —CF3 groups.

8. The composite membrane according to claim 1 wherein the discriminating layers each independently have an average thickness of 40 to 200 nm and the non-discriminating layer has an average thickness of 210 to 650 nm.

9. The composite membrane according to claim 1 wherein one or both of the discriminating layers comprise imide groups and the non-discriminating layer is free-from imide groups.

10. The composite membrane according to claim 1 wherein one or both of the discriminating layers comprise cellulose acetate and the non-discriminating layer is free-from cellulose acetate

11. (canceled)

12. A gas separation cartridge comprising a composite membrane according to claim 1.

13. A gas separation module for separating a feed gas containing a target gas into a gas stream rich in the target gas and a gas stream depleted in the target gas, the module comprises a housing and one or more cartridges according to claim 12.

14. A method for separating a feed gas containing a target gas into a gas stream rich in the target gas and a gas stream depleted in the target gas, which method comprises contacting the feed gas with a composite membrane according to claim 1, and collecting the gas which passes through the membrane and/or the gas which does not pass through the membrane.

15. The composite membrane according to claim 1 wherein the outermost layer (D) comprises 5 to 100 wt % polyimide polymer and the non-discriminating layer (E) comprises siloxane groups.

16. The composite membrane according to claim 1 wherein:
(i) the discriminating layers (C) and (D) each independently have an average thickness of 40 to 200 nm;
(ii) the discriminating layers (C) and (D) each comprise —CF3 groups;
(iii) the outermost layer (D) comprises 5 to 100 wt % polyimide polymer;
(iv) the non-discriminating layer (E) comprises siloxane groups;
(v) the non-discriminating layer (E) is free from —CF3 groups;
(vi) the non-discriminating layer (E) has an average thickness of 210 to 650 nm; and
(vii) the non-discriminating layer (E) is free-from imide groups.

17. The composite membrane according to claim 1 wherein one or both of the discriminating layers comprises a polymer comprising groups of the Formula (1) wherein Ar is an aromatic group and R is a pendant carboxylic acid group, a sulphonic acid group, a hydroxyl group, a thiol group, an epoxy group or an oxetane group: [chemical structure]
